(19) United States
(12) Patent Application Publication
(10) Pub. No.: US 2018/0361767 A1
(43) Pub. Date: Dec. 20, 2018

(54) ROTOGRAVURE UNIT INCLUDING A PULL ROLLER AND NARROW-WEB ROTARY PRINTING MACHINE

(71) Applicant: HEIDELBERGER DRUCKMASCHINEN AG, Heidelberg (DE)

(72) Inventor: HANS SCHADL, HIRSCHAU (DE)

(21) Appl. No.: 16/001,002

(22) Filed: Jun. 6, 2018

(30) Foreign Application Priority Data
Jun. 19, 2017 (DE) 102017210170.9

(51) Int. Cl. B41M 1/10; B41F 13/02; B41F 9/18

(52) U.S. Cl. CPC B41M 1/10; B41F 9/18; B41F 13/02

(57) ABSTRACT

A rotogravure unit of a printing machine for printing on a web-shaped printing material includes a forme cylinder, an ink application device, an impression cylinder and guide rollers for guiding the printing material. A driven pull roller and a further roller form a roller pair for transporting the printing material. The rotogravure unit advantageously permits only a few waste products to be created when the machine is started up or restarted and in-register printing is made quickly possible.

### CROSS-REFERENCE TO RELATED APPLICATION

This application claims the priority, under 35 U.S.C. § 119, of German Patent Application DE 10 2017 210 170.9, filed Jun. 19, 2017; the prior application is herewith incorporated by reference in its entirety.

### BACKGROUND OF THE INVENTION

### Field of the Invention

The invention relates to a rotogravure unit of a printing machine for printing on web-shaped printing material, including a forme cylinder, an ink application device, an impression cylinder and guide rollers for guiding the printing material. The invention also relates to a narrow-web rotary printing machine having the printing unit.

### Description of the Related Art

A configuration of a rotogravure unit is shown, for instance, in European Patent EP 2 604 431 B1. A jacket surface of a gravure forme cylinder, which is also referred to as a forme cylinder, gravure cylinder, or printing cylinder, at least partly dips into an ink fountain which is filled with gravure ink and is disposed underneath the gravure forme cylinder. As the gravure cylinder rotates about its axis of symmetry, the depressions formed in the jacket surface pass through the fountain and fill with ink.

Excess ink is scraped off by at least one doctor blade engaged with the jacket surface. The gravure ink is transferred to a printing material that is pressed against the inked jacket surface of the gravure forme cylinder by an impression cylinder in a printing nip disposed in an upper angular section of the gravure forme cylinder.

A disadvantage of such gravure printing units is that after a machine stop that involves a disengagement of the impression cylinder, it takes a comparatively long time for a constant web tension to be regained. As a result, defective products are created up until that point.

Another disadvantage is that if register corrections are required and the position of the forme cylinders is changed, the web tension changes, too. Every stop of the gravure printing press involving a disengagement of the impression cylinders causes the register alignment to be lost.

### SUMMARY OF THE INVENTION

It is accordingly an object of the invention to provide a rotogravure unit including a pull roller, and a narrow-web rotary printing machine, which overcome or at least partly eliminate the hereinafore-mentioned disadvantages of the heretofore-known devices of this general type and in which only a few waste products are created during start-up and restart of the machine and register alignment is achieved quickly.

With the foregoing and other objects in view there is provided, in accordance with the invention, a rotogravure unit of a printing press for printing on a web-shaped printing material, in particular made of paper, cardboard, or plastic, which includes a forme cylinder, an ink application device, and an impression cylinder. Together, they cause ink to be transferred to the printing material. The rotogravure unit further includes guide rollers for guiding the printing material. The rotogravure unit advantageously further includes a driven pull roller integrated into the rotogravure unit and, together with a second or further roller, forms a roller pair that creates a printing material clamping location for transporting the printing material in a defined way.

While it is known for printing presses of the prior art to have a respective pull roller pair upstream and downstream of every printing unit, it has not been known to provide such a pull roller pair within every gravure unit. The known pull roller pairs are part of so-called upstream infeed units and downstream outfeed units as described, for instance, in International Publication WO 2010/049030 A2, corresponding to U.S. Publication 2011/0252989.

The rotogravure unit of the invention has the following advantages:
Better register alignment and at the same time quicker register adjustment.
Less waste created during start-up of the printing press because when the machine stops, web tension is maintained by the pull roller and the clamping location at the pull roller pair, despite the disengagement of the impression cylinder from the forme cylinder. Consequently, web tension no longer needs to be reestablished.
In accordance with the prior art, the forme cylinder in gravure units carries the image to be printed and transports the printing material. Thus, the possible printing length corresponds to the circumference of the forme cylinder. Printing length variation is impossible. However, since a rotogravure unit in accordance with invention has a driven pull roller for transporting the printing material, it is possible for the forme cylinder to be rotated minimally faster or more slowly to change the printing length.
Secure printing material transport through the gravure unit and the press is possible even if the forme cylinder and the impression cylinder are spaced apart from one another and no printing operation takes place.

In a particularly advantageous and thus preferred embodiment of the rotogravure unit of the invention, the pull roller is disposed shortly upstream of the forme cylinder.

In accordance with a first alternative, the pull roller may be in direct engagement with the impression cylinder. This means that the pull roller and the impression cylinder form a roller pair, providing a clamping location for the printing material. An advantage of such a pull roller configuration is that the length of printing material that is free between the clamping location and the printing nip formed by the impression and forme cylinders is minimized.

In a second alternative, the pull roller is disposed upstream of the impression cylinder as viewed in the direction of web travel and is spaced apart from the impression cylinder, forming a roller pair with a counterpart roller to create the clamping location for the printing material.

It is particularly advantageous if a servomotor that is actuatable by the machine control unit is assigned to the pull roller to drive the latter.

With the objects of the invention in view, there is concomitantly provided a narrow-web rotary printing machine including a plurality of printing units, at least one of which is constructed in accordance with the description provided above. In addition, the narrow-web rotary printing machine may include prior art pull roller pairs disposed upstream and downstream of all printing units, respectively, to form respective clamping locations for driving the web of printing material in a defined way.

Other features which are considered as characteristic for the invention are set forth in the appended claims. As far as it makes sense from a technical point of view, combinations of the invention as described above and of the advantageous further developments of the invention likewise form advantageous further developments of the invention.

Although the invention is illustrated and described herein as embodied in a rotogravure unit including a pull roller, and a narrow-web rotary printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing. Further advantages and embodiments of the invention that are advantageous in structural and functional terms will become apparent from the dependent claims and the description of exemplary embodiments with reference to the appended figures.

### BRIEF DESCRIPTION OF THE SEVERAL VIEWS OF THE DRAWING

FIG. 1 is a fragmentary, diagrammatic, front-elevational view of a first embodiment of a rotogravure unit of the invention;

FIG. 2 is a fragmentary, front-elevational view of a second embodiment of a rotogravure unit of the invention; and

FIG. 3 is a fragmentary, front-elevational view of a prior art rotogravure unit.

### DETAILED DESCRIPTION OF THE INVENTION

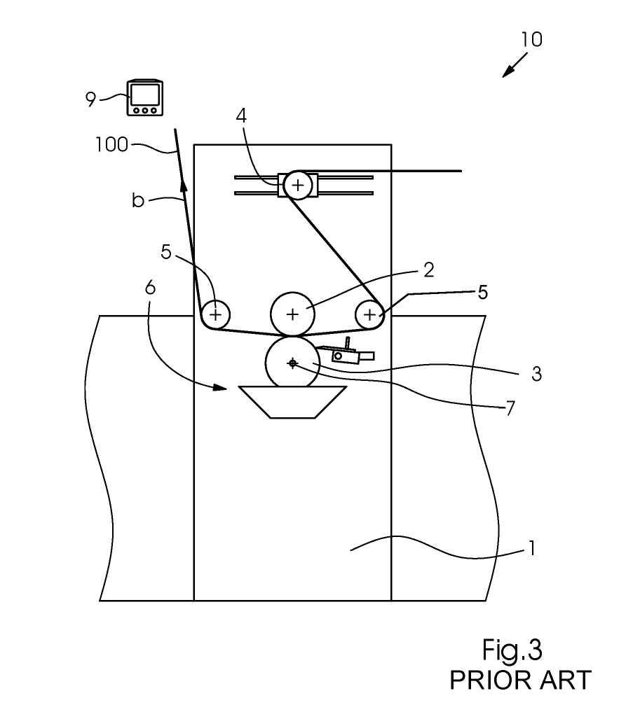

Referring now in detail to the figures of the drawings, which are not to scale and in which elements and components that correspond to one another have the same reference symbol, and first, particularly, to FIG. 3 thereof, there is seen a rotogravure unit 10 constructed in accordance with the prior art for printing on a web of printing material 100. A supporting structure of the printing unit 10 is formed by a printing unit frame 1. As is indicated by an arrow b, the web of printing material 10 passes through the rotogravure unit 10 as follows: coming from a non-illustrated upstream printing unit or a non-illustrated upstream processing unit, the web of printing material 100 travels into the rotogravure unit 10 through a web tension compensation device 4, where it is guided between a gravure cylinder 3 and an impression cylinder 2 by a first guide roller 5 to receive a print. Then the web of printing material 100 is guided by a second guide roller 5 before it leaves the gravure unit 10 to move on to a non-illustrated downstream further printing unit or a non-illustrated downstream processing unit. The forme cylinder 3 is driven by a servomotor 7 which is hidden behind the plane of the drawing. Thus, only a drive axle of the servomotor 7 is indicated in the figures. An ink application device 6 including an ink fountain and a doctor blade applies ink to the forme cylinder 3, which transfers the ink to the web of printing material 100.

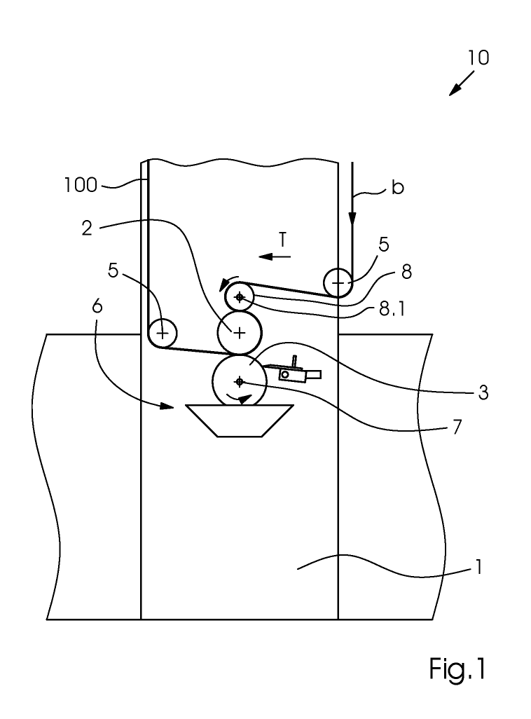

FIG. 1 illustrates a rotogravure unit 10 in accordance with the invention. The rotogravure unit 10 includes a printing unit frame 1 for receiving elements and components of the rotogravure unit 10. An ink application device 6 including an ink fountain and a doctor blade applies ink to a forme cylinder 3, which transfers the ink to the web of printing material 100. The web of printing material 100 is transported through the rotogravure unit 10 in a direction of web travel b and a direction of transport T. The forme cylinder 3 and the impression cylinder 2 form a printing nip through which the web of printing material 100 is transported to receive the print. In order to transfer a print, the forme cylinder 3, which is driven by a servomotor 7, is equipped with otherwise non-illustrated printing formes.

In the embodiment shown in FIG. 1, a pull roller 8 is disposed immediately upstream of the impression cylinder 2 and is engaged with the latter. Thus, the impression cylinder 2 and the pull roller 8 form a roller pair to create a nip or clamping location in which the web of printing material 100 is guided and transported in a defined way. The pull roller has a servomotor 8.1, which is not shown in any detail in FIG. 1. Non-driven co-rotating guide rollers 5 are provided to further guide the web of printing material 100.

The ink application device 6 may alternatively be constructed as a chambered doctor blade system.

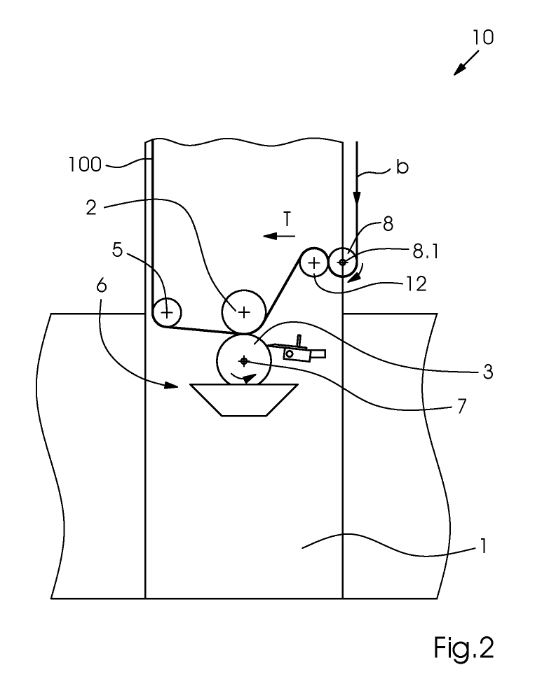

In the embodiment shown in FIG. 2, the rotogravure unit 10 likewise has a pull roller 8 driven by a servomotor 8.1. The pull roller 8 interacts with a counterpart roller 12 to form a pull roller pair and a clamping location for the web of printing material 100. The pull roller 8 and the counterpart roller 12 are disposed upstream of the impression cylinder 2 in such a way as to be spaced apart from the latter but still within the rotogravure unit 10.

The ink application device 6 may alternatively be constructed as a chambered doctor blade system.

The drives 7, 8.1 of the rotogravure unit 10 may be actuated by a control unit 9 (see FIG. 3).

The following is a summary list of reference numerals and the corresponding structure used in the above description of the invention:

### LIST OF REFERENCE SYMBOLS

1 printing unit frame
2 impression cylinder
3 forme cylinder
4 web tension compensation device
5 guide roller
6 ink application device
7 forme cylinder servomotor
8 pull roller
8.1 pull roller servomotor
9 control unit
10 rotogravure unit
12 counterpart roller
100 web of printing material
b direction of web travel

1. A rotogravure unit of a printing machine for printing on web-shaped printing material, the rotogravure unit comprising:
a forme cylinder;
an ink application device associated with said forme cylinder;
an impression cylinder associated with said forme cylinder;
guide rollers for guiding the printing material; and
a driven pull roller and a further roller, said pull roller and said further roller forming a roller pair for transporting the printing material.

2. The rotogravure unit according to claim 1, wherein said pull roller is disposed upstream of said forme cylinder.

3. The rotogravure unit according to claim 1, wherein said pull roller is engaged with said impression cylinder.

4. The rotogravure unit according to claim 1, wherein said further roller is a counterpart roller, and said pull roller is disposed upstream of said impression cylinder and forms said roller pair with said counterpart roller.

5. The rotogravure unit according to claim 1, which further comprises a servomotor associated with said pull roller, and a machine control unit for actuating said servomotor.

6. A narrow-web rotary printing machine, comprising:
a plurality of printing units, at least one of said printing units being a rotogravure unit according to claim 1.
